(19) United States
(12) Patent Application Publication
(10) Pub. No.: US 2026/0342036 A1
(43) Pub. Date: Oct. 29, 2026

(54) METHOD FOR STABILISING THE FREQUENCY OF A Q-SWITCHED NARROW-BAND LASER

(71) Applicants: Fraunhofer-Gesellschaft zur Förderung der angewandten Forschung e.V., München (DE); Airbus Defence and Space GmbH, Taufkirchen (DE)

(72) Inventors: Dominik ESSER, Aachen (DE); Christian WÜHRER, Taufkirchen (DE)

(73) Assignees: Fraunhofer-Gesellschaft zur Förderung der angewandten Forschung e.V., München (DE); Airbus Defence and Space GmbH, Taufkirchen (DE)

(21) Appl. No.: 19/156,045

(22) PCT Filed: Dec. 21, 2023
(86) PCT No.: PCT/EP2023/087381

§ 371 Date: Aug. 13, 2025

(30) Foreign Application Priority Data
Feb. 16, 2023 (DE) 10 2023 103 793.5

(51) Int. Cl. H01S 3/139; H01S 3/115

(52) U.S. Cl. CPC H01S 3/139; H01S 3/115

(57) ABSTRACT

A method for stabilising the frequency of a narrow-band Q-switched laser includes coupling laser radiation from a seed laser with a wavelength at which the laser pulses are to be generated into a laser resonator, detecting a temporal intensity profile of laser radiation from the seed laser, and regulating the optical resonator length of the laser resonator in each regulating period between two laser pulses based on an approximately constant temporal average value. The optical resonator length of the laser resonator is changed in the temporal range of the generation of a laser pulse, starting from an initial value that is known due to the previous regulating process, to a resonance value at which the laser resonator is in resonance with the wavelength of the seed laser when the Q-switch is switched, and, when said resonance value is reached, the Q-switch is switched in order to generate a laser pulse.

### TECHNICAL APPLICATION AREA

The present invention relates to a method for stabilising the frequency of a narrow-band laser which includes a laser resonator of variable resonator length, with an active Q-switch for generating laser pulses, in which laser radiation from a seed laser with a wavelength at which the laser pulses are to be generated is coupled into the laser resonator. The invention also relates to a laser assembly for carrying out the method.

Q-switched lasers generally have a spectral bandwidth that covers many longitudinal modes of the laser resonator. Exceptions are, for example, laser beam sources that, due to a short resonator, have such large longitudinal mode spacing that no more than one mode can be amplified in the active medium. These are usually sources with a passive Q-switch, since the installation space of an active Q-switch alone normally requires a resonator length that makes the above condition impossible to fulfil.

If the application requires narrow spectral bandwidth, the laser must be manipulated in such a way that fewer longitudinal modes are excited and amplified. This is often done by “seeding” the laser oscillator with a narrow-band laser, the “seed laser”. This seed laser provides an effective photon density of the preferred wavelength in the resonator of the laser whose frequency is to be stabilised; this photon density is several orders of magnitude higher than the natural, fluorescence-related wavelength and excites the resonator at this wavelength. If only the one longitudinal mode in the resonator that corresponds to the frequency of the seed laser is to be excited and amplified, the orbital length of the laser resonator must be a multiple of the wavelength of the seed laser. The seed laser must have a sufficiently narrow band to ensure monofrequency operation of the laser for a given free spectral range and time-bandwidth limit. As a rule, a seed laser with a bandwidth that is less than about 10-20% of the time-bandwidth limit of the oscillator is used. For stable monofrequency or narrow-band operation of a Q-switched laser at wavelengths in the VIS to NIR from about 400 nm to about 3 μm, the resonator length may therefore only fluctuate by fractions of a nanometre. However, larger fluctuations are generated by nothing more than natural thermal drift, and especially vibrations. It is therefore necessary to actively regulate and thus stabilise the resonator length of the laser.

### PRIOR ART

A proven method for controlling the resonator length for monofrequency and correspondingly narrow-band operation of a Q-switched laser is the ramp-fire method, as described for example in S. W. Henderson et al., “Fast resonance-detection technique for single-frequency operation of injection-seeded Nd:YAG lasers”, Optics Letters, Vol. 11, No. 11, Nov. 1986. One of the mirrors of the laser resonator is displaced axially, so the resonator may be considered a scanning Fabry-Perot interferometer. Piezo actuators with which a stroke of a few μm on a time scale of 10 μs to 500 μs is possible, have proven suitable for this, for example. In the ramp-fire method, the resonator orbit length is changed approximately linearly by at least one wavelength during seeding of the laser resonator, and the transmittance of the resonator at the wavelength of the seed laser is measured with a photodiode (qualitatively). This results in the typical transmission signal of a scanning Fabry-Perot interferometer for a monofrequency signal. In the transmission maxima, the resonator is in resonance with the seed signal and the Q-switch of the laser resonator can be triggered. If the optical resonator length is changed during Q-switching, the resulting change in length must be compensated, since the switched resonator with the same geometric length is no longer in resonance with the resonant unswitched resonator. This is the case, for example, when a Pockels cell consisting of a birefringent crystal that changes the refractive index in one axis when switched is used as a Q-switch. Compensation is carried out with a fixed delay of the switching process with respect to the previously detected resonance, in which the piezo actuator makes the corresponding change in the optical resonator length geometrically and compensates for the change caused by Q-switching. The laser resonator then emits a correspondingly narrow-band or monofrequency laser pulse. Other methods for tuning the optical path length of the resonator to the seed laser are also possible, for example based on acousto-optical or electro-optical modulators instead of piezo actuators.

The ramp-fire method has the great advantage that the time period between the information about the resonance and the laser pulse is very short. Depending on the configuration, it is typically only a few nanoseconds to a few microseconds. This means that disruptive external influences have only a very small effect on the system, so that the ramp-fire method generally enables very stable monofrequency operation. Furthermore, the piezo actuator follows a fixed, almost linear ramp; the actuator position is not used as a control variable. This means that the inertia due to the mass of the actuator and its hysteresis do not represent a direct limit for control accuracy. However, the accuracy of the method increases with the ramp steepness, i.e. the speed of the linear change in length through the piezo actuator, since as the speed increases the time period between the information about the resonance and the laser pulse becomes shorter, and the increased sharpness of the resonance signal makes (electronic) detection more precise. Here, however, the mass-induced inertia of the actuator indirectly represents a limit for control accuracy because it limits the steepness of the ramp.

However, the ramp-fire method also has fundamental disadvantages. For example, the exact point in time of the resonance and thus the exact time of emission of the laser pulse is not known a priori. It is variable by a free spectral range or by the corresponding time equivalent given by the travel speed of the piezo actuator, typically a period of 10 μs and more. On the one hand, this means that the gain in the active medium is generally different for each pulse, since it changes on a μs time scale with constant pumping or non-pumping. The result is undesirable energy fluctuations from pulse to pulse. On the other hand, the synchronisation of other devices belonging to the laser system is made considerably more difficult or even impossible, particularly if these other devices are triggered at a fixed time relative to the laser pulse but have to be triggered before the laser pulse due to internal delays. A further disadvantage is the mechanical load on the actuator used for the length change. The linear ramp and in particular the powerful accelerations at the start and end of the ramp place a very heavy mechanical load on the actuator. This load shortens the service life and is undesirable for applications in which the actuator can only be replaced with great effort or not at all. The load on the actuator increases with the steepness of the ramp, but this also increases the accuracy of the process and thus the frequency stability of the resonator. Frequency stability and load on the actuator are therefore in conflict. A flatter ramp also exacerbates the problem of pulse energy fluctuations, since the time interval for the laser pulse triggering increases as the ramp becomes less steep.

The last disadvantage described is particularly relevant for satellite applications. In an electro-optical or acousto-optical Q-switched laser with amplifier and frequency converter, there are no mechanically stressed or moving components without control of the resonator length. However, if the resonator is controlled with a piezo actuator, as the only mechanically moving element, the piezo actuator has the highest failure probability of all of the laser components and thus represents a limiting factor for the duration of a satellite-supported mission. Redundancy by installing another piezo actuator on another resonator mirror is undesirable for reasons of the optomechanical stability of the oscillator.

Other methods of resonator length control are known from the state of the art, which completely or partially avoid the disadvantages of the ramp-fire method described above, but at the expense of frequency stability.

For example, DE 102007003759 B4 describes a modified ramp-fire method in which the time of occurrence of resonance when driving the piezo ramp is predicted with a lead time of a few tens of μs. The prediction is made based on the measured time of occurrence of the first detected resonance, which is related to the time of occurrence of a subsequent resonance in which the Q-switch is triggered. This is then known with a lead time of a few tens of μs, so that other devices can be synchronised with the laser pulse. However, the problems of the uncertain triggering time in the gain curve and the high load on the piezo actuator remain unresolved. Furthermore, the accuracy is reduced by the deviation from the linearity of the piezo travel path to the voltage.

In the Pound-Drever-Hall (PDH) and Hänsch-Couillaud (HC) methods, as described in Drever, R. W. P. et al., “Laser phase and frequency stabilization using an optical resonator”, Appl. Phys. B Photophysics and Laser Chemistry, Springer Science and Business Media LLC, 1983, 31, 97-105 and in Hänsch, T. et al., “Laser frequency stabilization by polarization spectroscopy of a reflecting reference cavity”, Opt. Comm., Elsevier BV, 1980, 35, 441-444, the error signal (electronic detection of modulated sidebands (PDH) or polarization change (HC) ) is obtained for control almost in real time. Here, the piezo actuator is readjusted continuously, its inertia represents the limiting factor for the bandwidth of the controllable disturbances. Accordingly, this is in the order of several 100 Hz. Especially in the pumping phase, the optical resonator length changes dynamically within a time period of 100 μs, so that control frequencies significantly greater than 10 kHz would be required.

In the Ramp-Hold-Fire method, as described in T. Walther et al., “Generation of Fourier-transform-limited 35-ns pulses with a ramp-hold-fire seeding technique in a Ti:sapphire laser, ”Appl. Opt. 40, 3046-3050 (2001), the piezo actuator travels over a ramp and is stopped when a resonance occurs. The pulse can then be triggered at a previously known time. It is typically necessary to wait a few 10 μs before the Q-switch is triggered because of the post-pulse oscillation of the piezo elements and mechanical elements, which makes the process more susceptible to interference than the classic ramp-fire process. In this context, it is also no longer possible to take into account the influence of the change in resonator length due to the gain change in the laser crystal until the end, which results in poorer stability. Furthermore, the load on the actuator is just as great as with the ramp-fire process.

Another method known to the inventors for controlling the resonator length is the “cavity dither” method. In this method, the resonator length is constantly changed harmonically by the piezo movement (“dithering”). The control electronics use the transmission signal to determine the piezo position in which the laser resonator is resonant to the seed signal. The Q-switch of the laser resonator is triggered at a fixed, known point in time, wherein the resonance position (plus compensation offset) must be reached immediately before the Q-switching. This works for a steady state. If pumping is carried out during dithering, the dithering, i.e. the harmonic change in the resonator length, must compensate for the optical resonator length change induced by the pumping. In order to keep the load on the piezo actuator low, the dither frequency should not exceed the order of 1 kHz. If the resonator is pumped in pulses because of the ratio of the storage time of the active medium to the pulse repetition rate and the storage time is much shorter than 1 ms (example: Nd:YAG oscillator, storage time 230 μs, pulse repetition rate 100 Hz), the influence of the pumping can then no longer be compensated for by dithering. The influence of pumping on the optical resonator length must then be regarded as (almost) constant and taken into account when determining the compensation offset mentioned above. The load on the piezo actuator is significantly lower than with the ramp-fire method, but so is the frequency stability, since the time period between the information about the state of the resonator and the triggering of the Q-switch is relatively long with dither frequencies around 1 kHz.

The object of the present invention is to provide a method and assembly for stabilising the frequency of a Q-switched, narrow-band or longitudinally monofrequency laser, which enables reduced mechanical load on the element that regulates the resonator length, with high frequency stability and in which the time of emission of the respective laser pulse is known a priori.

### Presentation of the Invention

The object is achieved with the method and the laser assembly according to Claims 1 and 11. Advantageous variants of the method and of the laser assembly are the subject matter of the dependent claims or may be discerned from the following description and exemplary embodiment.

In the suggested method, the laser radiation of a narrow-band seed laser with a wavelength at which the laser pulses of the laser whose frequency is to be stabilised are to be generated is coupled into the laser resonator. A temporal intensity profile of the laser radiation of the seed laser coupled out of the laser resonator is detected, and the optical resonator length of the laser resonator is regulated to an approximately constant temporal average in each period between two laser pulses, hereinafter referred to as the control period, on the basis of the detected temporal intensity profile by periodic variation and adaptation of an offset of the variation. The resonator length is thus dithered periodically in the control period. The transmitted seed signal is also periodic, but drifts with, for example, thermal changes in the resonator length. The response signal and thus the resonator length is stabilised by regulating the offset of the dither movement. The periodic variation is carried out in such a way that the mechanical load on the actuator is as low as possible, in particular lower than in the ramp-fire method. The variation is preferably carried out harmonically or at least approximately harmonically. In this context, the laser radiation of the seed laser can be coupled in and out in the same way as with the known methods of controlling the resonator length of the prior art mentioned in the introduction to the description. The optical resonator length of the laser resonator is then changed in the temporal range of each generation of a laser pulse, hereinafter also referred to as the trigger period, starting from an initial value known from the previous regulation, to a value (and beyond), hereinafter referred to as the resonance value, at which the laser resonator is in resonance with the wavelength of the seed laser after switching the Q-switch. When this resonance value is reached, the Q-switch is switched to generate a laser pulse. A resonance before the Q-switch is switched is detected on the basis of the transmitted seed signal, and the Q-switch is switched, optionally with a time delay to compensate for circuit-induced changes in the optical resonator length. The change or variation in the optical resonator length of the laser is preferably brought about by mechanical movement of a mirror of the resonator. A piezo actuator is preferably used for this. In the case of a Nd:YAG laser to be stabilised, for example, the triggering period may be in the range from 10 μs to 100 μs, the control period may be in the range from 10 ms to 20 ms, an example of a dither frequency is approximately 1 kHz.

The switching point of the Q-switch should coincide as closely as possible with the point in time of the maximum pump inversion. Because of the regulation, the initial value of the optical resonator length relative to the resonance value to be achieved is known at the start of the triggering phase. The rate of change or the variation of the optical resonator length is then selected in the triggering phase such that the resonance value is reached at least approximately at the same time as the desired switching point. As explained in more detail below, this can be achieved by a linear change in the resonator length, but preferably by suitable synchronisation of the periodic variation, such that the resonance value—and therewith the point in time of switching as well—occurs in each case in a phase that is as linear as possible of the preferably harmonic variation. The corresponding values (initial value and resonance value and the difference between them) can be determined by preliminary tests with the laser assembly. Changes in the optical resonator length that may occur during switching are taken into account.

The optical resonator length is regulated during the control periods preferably by maintaining a fixed relationship between the variation of the optical resonator length and the temporal intensity profile of the laser radiation of the seed laser coupled out of the laser resonator. For this purpose, the voltage value by which the voltage applied to the piezo actuator is varied accordingly, preferably harmonically, is adapted or changed appropriately in the course of a variation effected by moving a resonator mirror using a piezo actuator.

The change in the optical resonator length in the triggering phase may be linear, i.e. the resonator length is changed in a ramp-like manner as in the ramp-fire method described in the introduction. The ramp in this case can be chosen to be flatter than in the ramp-fire method, with better predictability of the triggering time and with lower actuator load. Alternatively, the change in the resonator length in this phase can also take place in another form, preferably maintaining a harmonic or at least approximately harmonic movement. The harmonic movement is then preferably chosen such that the resonance value lies in the region of an inflection point of the harmonic movement.

A narrow-band laser is understood to be a laser with a laser emission whose bandwidth is smaller than the free spectral range of the laser resonator. For example, the laser emission may have a half-width of less than 50 MHz, preferably less than 20 MHz. The frequency stabilisation takes place around the centre frequency of this spectral emission. In the following text, such a laser is also referred to as a monofrequency laser.

Two cases can be distinguished: the case of pulsed pumping of the laser and the case of continuous pumping (continuous wave) of the laser.

If the laser is pumped in a pulsed manner, the resonator length is varied periodically during the pause phase between two pump pulses, also called dithering. The regulating period therefore corresponds to the pause phase. The periodic variation is preferably carried out by a corresponding harmonic or nearly harmonic movement of one of the mirrors by voltage, current or charge modulation with a piezo actuator. The signal of the narrow-band seed laser transmitted through the laser resonator as a reference laser is detected with a suitable detector, preferably a photodiode. If the dither amplitude, i.e. the amplitude of the periodic variation of the resonator length, is smaller than a free spectral range of the laser resonator, the detection signal oscillates at twice the dither frequency. The profile of the signal fluctuates relative to the dither movement due to changes in the resonator length, which are caused, for example, by vibrations or thermal drift. When a piezo actuator is used, the signal profile of the detection signal can be controlled by means of the voltage offset of the dither. It is stabilised to the dither movement by means of control electronics. Dithering, i.e. the periodic change in resonator length or movement of one of the mirrors, thus occurs by a value that is continuously adjusted during the dithering in order to maintain a constant relationship between the dither movement and the photodiode signal. The dither frequency in the suggested method is preferably not more than 10 kHz. The variation in the resonator length, i.e. in particular the movement of the piezo actuator, is changed from dithering to a linear ramp, for example, shortly before the desired Q-switch triggering time. The voltage interval of the ramp must contain at least one resonance state. The Q-switch is triggered at the time of resonance plus any temporal compensation for circuit-related changes in the optical resonator length.

In the case of a continuous wave pumped laser, the gain and therewith the optical resonator length changes continuously due to the pumping. Accordingly, the dither period in the regulating period must be chosen appropriately in order to be able to adjust these changes. With a constant pumping rate and thus a known rate of change of the optical resonator length, the change may be compensated for independently of the dither control, e.g. by a continuous, static offset adjustment. The triggering phase then runs in the same way as in the case of pulsed pumping.

Due to dithering the state of the laser resonator at the start of the triggering phase, is very well known, particularly during a ramp run. Disturbances with frequencies below the dither period can be corrected. This makes it very easy to predict when the resonator is resonant with the seed laser during the ramp run. The dither and ramp parameters can be selected such that the laser resonator is resonant exactly at the gain maximum. Changes to the optical resonator length caused by pumping of the active medium during the ramp run are the same in each period and can easily be compensated for. The ramp can then be driven with a relatively shallow gradient and thus with low load on the actuator, without causing any temporal fluctuations and consequently energy fluctuations in the laser pulse. The actuator protection can be further improved by making the transitions from dithering to linear movement and vice versa as harmonious as possible in order to avoid large accelerations.

In an alternative embodiment of the method, dithering can be maintained in the triggering phase as well, instead of a linear movement (ramp run). Ideally, the dither parameters are adjusted before the triggering phase in such a way that the dithering movement is at an inflection point at the switching time in the triggering phase. At the inflection points, a harmonic movement is approximately linear for a short time. Moreover, the first derivative is greatest after the time, which maximises the resonance signal sharpness. If it is necessary due to the change in resonator length, the dither amplitude can also be increased briefly in the triggering phase in order to improve the steepness at the inflection point and thus the signal sharpness. The steeper section achieved in this way (at the inflection point) is non-critical compared to a correspondingly steep ramp in the ramp-fire method, since the accelerations for the actuator are smaller due to the harmonic movement.

The suggested laser assembly for carrying out the method accordingly comprises a laser resonator with active medium and active Q-switch as well as an actuator, via which the resonator length can be changed in the range of a few um by moving one of the mirrors of the laser resonator. This is preferably a piezo actuator. Of course, other optical elements can also be arranged in the laser resonator if required. The laser assembly further comprises a narrow-band seed laser, the laser radiation of which is coupled into the laser resonator. A portion of the radiation of the seed laser circulating in the resonator is decoupled again and directed to a suitable photodetector. For this purpose, corresponding coupling and decoupling elements may also be arranged in the laser resonator if the coupling and decoupling do not take place via one of the mirrors. The assembly comprises a control device which receives the signal detected by the photodetector and controls the actuator according to the suggested method in the regulating periods to generate a dither movement of the relevant mirror and adjust to an approximately constant temporal average of the optical resonator length, and in the trigger phases to change the resonator length to the resonance value. This control device also controls the active Q-switch to switch when the resonance value is reached.

The suggested method achieves a lower load on the element that changes the resonator length of a narrow-band or monofrequency laser with high frequency stability compared to the state of the art described in the introduction. This significantly reduces the probability of failure of frequency-stable narrow-band, Q-switched lasers, since the element that changes the resonator length is subjected to considerably less load than in the previously established methods. The advantages of the suggested method are revealed particularly in application areas in which a piezo actuator is used as the element that changes the resonator length and can only be replaced with great effort or not at all. Examples of such applications are aircraft- or satellite-based laser systems, for LIDAR applications for example. The costs of an airborne research campaign that must be aborted due to a piezo actuator failure are very high. In a satellite mission, replacing the piezo actuator is practically impossible. This can also significantly reduce the development and qualification costs for a piezo actuator used in a satellite mission, as the requirements imposed on it are considerably lower due to the lower load entailed by the suggested method. The method can generally be used advantageously for all applications that require high frequency stability of the emitted laser radiation in an unstable environment while at the same time placing low load on the element that changes the resonator length. With this method, the time of emission of the laser pulse is also known more precisely, as the resonator length is regulated correspondingly between the trigger phases. This enables synchronisation of other devices associated with the laser system that must have a fixed time relative to the laser pulse.

### BRIEF DESCRIPTION OF THE DRAWINGS

The suggested method and the associated laser assembly will be explained briefly again in the following text with reference to a design example in conjunction with the drawings. In the drawings:

FIG. 1 shows a highly schematic representation of an exemplary structure of the suggested laser assembly; and

FIG. 2 shows an example of the control of a piezo actuator for changing the resonator length according to the suggested method and an exemplary profile of the photodiode signal of the seed laser transmitted through the resonator during the regulating period.

### WAYS TO IMPLEMENT THE INVENTION

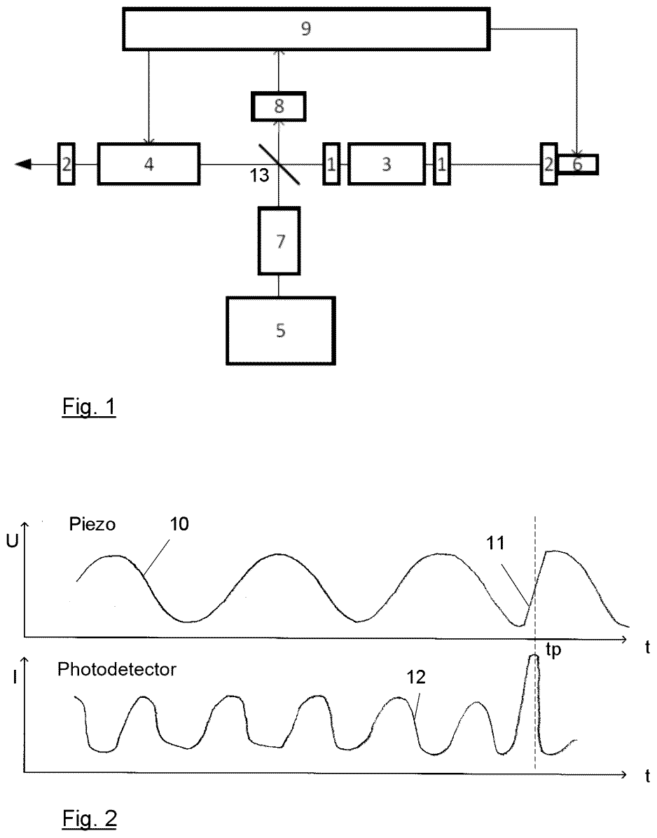

FIG. 1 shows a highly schematic example of the suggested laser assembly for stabilising the frequency of a narrow-band, Q-switched laser. In this example, the laser whose frequency is to be stabilised has a linear laser resonator made up of two mirrors 2 with an active medium 3 and a Q-switch 4. A Pockels cell, for example, can be used as the Q-switch 4. The pump assembly for pumping the active medium 3 is not shown in FIG. 1. Depending on the active medium, the pumping may be performed optically, for example, using suitable pump diodes. The laser assembly also has a seed laser 5, the narrow-band laser radiation from which is coupled into the laser resonator of the laser. The centre wavelength of the narrow-band seed laser radiation corresponds to the wavelength of the laser that is to be stabilised. The resonator length of the laser must be tuned to this wavelength for stabilisation with regard to the resonance condition. However, external influences, such as vibrations or even thermal effects, change the resonator length of the laser. Therefore, the resonator length must be appropriately regulated in order to stabilise it. In this example, one of the mirrors 2 is moved axially via a piezo actuator 6 for this purpose. In the present example, an optical isolator 7, for example a Faraday isolator, is arranged between the seed laser 5 and the laser in order to prevent feedback of the laser radiation emerging from the laser towards the seed laser 5 into the seed laser 5. In addition, a λ/4 plate 1 may be arranged on either side of the active medium 3 in order to avoid spatial hole burning. Via this optical isolator 7, a seed signal transmitted through the laser resonator of the laser is directed at an optical detector 8, for example a photodiode, which detects the temporal intensity profile of the seed laser radiation transmitted through the laser resonator.

In the suggested laser assembly and the associated method, the piezo actuator 6 is controlled harmonically via a control device 9 in the time period between two laser pulses, so that the resonator length is increased and decreased approximately harmonically. The value by which the resonator length varies, i.e. by which the harmonic movement occurs, is regulated during this time via the detection signal of the detector 8, which is fed to the control device 9, so that a fixed relationship is established between the detection signal of the detector 8 and the harmonic movement of the resonator length. In this way, changes in the optical resonator length that are slow compared to the frequency of the harmonic movement can be compensated for. In the area of generation of a laser pulse, i.e. in the triggering phase, in the present example the resonator length is then changed approximately linearly via the piezo actuator 6 to a value (and beyond) at which the resonator—also taking into account possible optical length changes during the switching process is in resonance with the wavelength of the seed laser. When this value is reached, referred to as the resonance value in the present patent application, the Q-switch 4 is switched. This switching of the Q-switch 4 is also carried out via the control device 9.

The upper part of FIG. 2 shows an example of a voltage U applied to the piezo actuator 6 as a function of time, starting in the period between two laser pulses (regulating period) through the triggering phase and into the next regulating period for the next laser pulse. The harmonic progression of the voltage 10 leads to a corresponding variation in the resonator length. In the area where a laser pulse is triggered, a ramp 11, i.e. an almost linear increase in the voltage at the piezo actuator—corresponding to a linear change in the resonator length—is then run, and when the value corresponding to a resonance is reached (at time point to) within this ramp, a laser pulse is triggered. Then, after a steady state has been reached, the system switches back to harmonic control. The lower part of the figure shows an exemplary detection signal 12, which is captured by the detector 8 of the laser assembly. This wave-like detection signal obtained by the harmonic motion is used to compensate for changes in the resonator length that are not caused by the harmonic control of the piezo actuator. To do this, the centre value of the voltage 10 at the piezo actuator, around which the harmonic variation occurs, is regulated in such a way that a fixed relationship is maintained between the detection signal 12 and the voltage 10 at the piezo actuator.

Due to the harmonic control between two laser pulses and the corresponding regulation of the resonator length, the load on the piezo actuator is relatively low in this case, and the state of the laser resonator at the beginning of the triggering phase is very well known. This makes it very easy to predict when the resonator will be resonant to the seed laser during the subsequent travel, especially the ramp run. The good a priori knowledge of the resonance point allows a flatter ramp, so that this movement can also be driven in a way that protects the actuator, without causing temporal fluctuations and thus energy fluctuations in the laser pulse.

### LIST OF REFERENCE SYMBOLS

λ/4 plate
2 Resonator mirror
3 Active medium
4 Q-switch
5 Seed laser
6 Piezo actuator
7 Optical isolator
8 Optical detector
9 Control device
10 Harmonic voltage signal
11 Ramp-shaped voltage signal
12 Detection signal
13 Polarisation beam splitter
tₚ Switching time

1. Method for stabilising the frequency of a narrow-band laser having a laser resonator of variable optical resonator length with an active Q-switch for generating laser pulses, in which
laser radiation from a seed laser with a wavelength at which the laser pulses are to be generated is coupled into the laser resonator,
a temporal intensity profile of laser radiation of the seed laser coupled out of the laser resonator is detected and the optical resonator length of the laser resonator is regulated in a control period between each two laser pulses on the basis of the simultaneously detected temporal intensity profile by periodic variation and adaptation of an offset of the variation to an approximately constant temporal average,
the optical resonator length of the laser resonator is changed in each time range of the generation of a laser pulse starting from an initial value known from the previous regulation beyond a resonance value at which the laser resonator will be in resonance with the wavelength of the seed laser after the Q-switch is switched, and
the Q-switch [[(4)]] is switched in order to generate a laser pulse when this resonance value is reached.

2. Method according to claim 1,
characterized in that
the regulation of the optical resonator length of the laser resonator to the approximately constant temporal average value in the regulation period is carried out by maintaining a fixed relationship between the periodic variation of the optical resonator length and the detected temporal intensity profile of the laser radiation coupled out of the laser resonator.

3. Method according to claim 1,
characterized in that
the optical resonator length of the laser resonator is changed linearly from the initial value beyond the resonance value in the temporal range of the generation of a laser pulse.

4. Method according to claim 1,
characterized in that
the optical resonator length of the laser resonator is changed in the temporal range of the generation of a laser pulse by the periodic variation from the initial value to the resonance value.

5. Method according to claim 4,
characterized in that
an amplitude of the periodic variation is increased in the temporal range of the generation of a laser pulse.

6. Method according to claim 4,
characterized in that
the periodic variation is harmonic or approximately harmonic and is selected such that the resonance value lies in the region of an inflection point of the harmonic or approximately harmonic variation.

7. Method according to claim 1,
characterized in that
the change in the optical resonator length of the laser resonator is carried out by displacement of a resonator mirror with an actuator.

8. Method according to claim 7,
characterized in that
the change in the optical resonator length of the laser resonator is carried out by displacement of a resonator mirror with a piezo actuator.

9. Method according to claim 1.
characterized in that
the change in the optical resonator length of the laser resonator is carried out by a phase shifter.

10. Method according to claim 1,
characterized in that
the laser is pumped in pulsed manner, wherein the temporal range of the generation of a laser pulse corresponds to a pumping phase, and the regulating period corresponds to the time period between the pumping phases.

11. Laser assembly with at least
a laser resonator with active medium and active Q-switch, and an actuator via which a resonator length of the laser resonator can be changed by moving a mirror of the laser resonator,
a seed laser whose laser radiation is coupled into the laser resonator,
a photodetector which detects laser radiation of the seed laser that is coupled out of the laser resonator, and
a control device to which the photodetector is connected and which is designed to control the actuator and the Q-switch according to the method of claim 1.
